(19) United States
(12) Patent Application Publication
(10) Pub. No.: US 2023/0366229 A1
(43) Pub. Date: Nov. 16, 2023

(54) POOL SKIMMING APPARATUS

(71) Applicants: Jennifer Rever, Tiny (CA); Stephen Grozelle, Tiny (CA)

(72) Inventors: Jennifer Rever, Tiny (CA); Stephen Grozelle, Tiny (CA)

(21) Appl. No.: 17/742,301

(22) Filed: May 11, 2022

(51) Int. Cl. E04H 4/16; B01D 29/05

(52) U.S. Cl. CPC E04H 4/1609; B01D 29/05; B01D 2201/0415

(57) ABSTRACT

A pool skimming apparatus includes a net and a pair of elongated poles located either side of the net. The net includes an elongated length that is sized substantially equal to (in some examples) a width of the pool. As such, two users stand either side of the width of the pool, place the net in the pool and walk together from one side of the length of the pool to the other, thereby skimming debris from the pool quickly and easily.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of pool accessories of existing art and more specifically relates to a pool skimmer apparatus.

### RELATED ART

Swimming pools, or simply pools, are either outdoor or indoor structures that hold water for swimming or for other leisure purposes. However, a well-known problem for anyone that has maintained a pool, or even used a pool, is the accumulation of debris that happens on the surface of the pool. This is particularly true for outdoor pools, as insects, leaves, and the like very quickly collect on the pool surface. Current methods for removing the debris from the pool include the use of nets. However, these current nets typically include a long handle and a small net on the end of the long handle. As such, cleaning a pool, particularly a large pool, takes an unnecessary amount of time. This thereby minimizes time that is able to be spent in the pool, increases cost spent on pool cleaning services, and/or is inefficient for the pool cleaner themselves. As such, a suitable solution is desired.

### SUMMARY OF THE INVENTION

In view of the foregoing disadvantages inherent in the known pool accessory art, the present disclosure provides a novel pool skimming apparatus. The general purpose of the present disclosure, which will be described subsequently in greater detail, is to provide an apparatus that is operated by two people and enables quick and effective pool skimming.

An apparatus for skimming debris from a pool is disclosed herein. The apparatus may include a net, a first elongated pole and a second elongated pole. The net may be configured to trap the debris thereon. The net may include a flexible mesh screen material, a first side opposite a second side and an elongate net length therebetween. The elongate net length may be substantially equal to either the width or length of the pool. The first elongated pole may be configured to be grasped by a first user and the second elongated pole may be configured to be grasped by a second user. The first elongated pole may include a first top end opposite a first bottom end and a first elongated pole length therebetween. The first side of the net may be attached about the first bottom end of the first elongated pole. Similarly, the second elongated pole may include a second top end opposite a second bottom end and a second elongated pole length therebetween. The second side of the net may be attached about the second bottom end of the second elongated pole.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a pool skimming apparatus, constructed and operative according to the teachings of the present disclosure.

FIG. 1 is a front perspective view of an apparatus being used to skim a pool by two users, according to an embodiment of the disclosure.

FIG. 2 is a side perspective view of the apparatus in the pool, according to an embodiment of the present disclosure.

FIG. 3 is a top view of the apparatus in the pool, according to an embodiment of the present disclosure.

FIG. 4 is a cross-sectional view taken from line 4-4 in FIG. 3, according to an embodiment of the present disclosure.

FIG. 5 is a front perspective view of the apparatus including a net, a first elongated pole and a second elongated pole, the apparatus being in an in-use position, according to an embodiment of the disclosure.

FIG. 6 is a close-up partial exploded view of the apparatus illustrating the net being attached to the second elongated pole via a metal bar and four screws, according to an embodiment of the disclosure.

FIG. 7 is a front perspective view of the apparatus in a storage position, according to an embodiment of the disclosure.

FIG. 8 is a side view of the apparatus, according to an embodiment of the disclosure.

The various embodiments of the present invention will hereinafter be described in conjunction with the appended drawings, wherein like designations denote like elements.

### DETAILED DESCRIPTION

As discussed above, embodiments of the present disclosure relate to a pool skimming apparatus. Generally, the pool skimming apparatus may be a tool in which makes pool skimming fastener and easier; enabling two users to clean debris from a pool within minutes. The pool skimming apparatus may include a net that reaches between two sides of the pool and handles on either side of the net that the users hold on to. The pool may be a pool of any size. For example, the pool may include a width of 10 feet, 15 feet, 20 feet, etc.

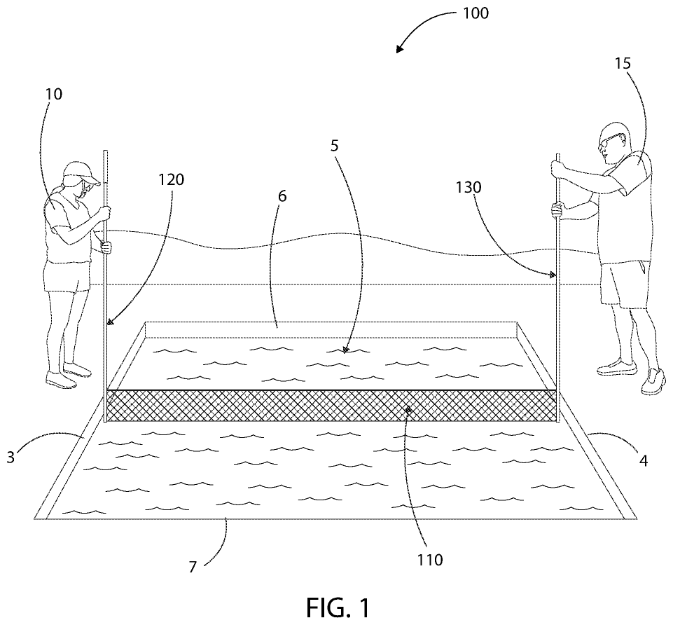

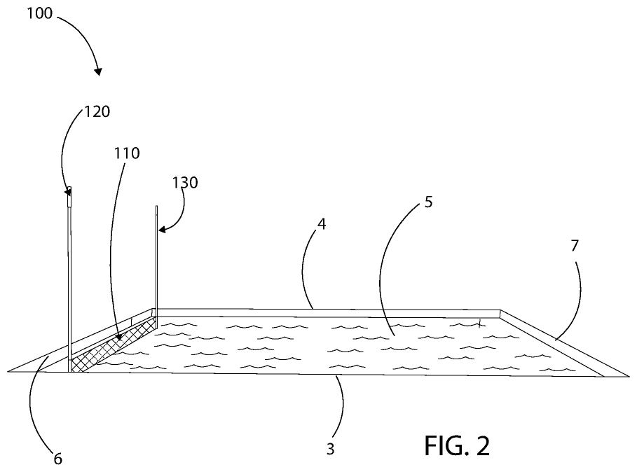

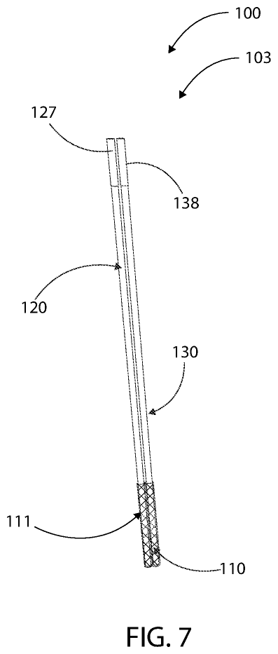

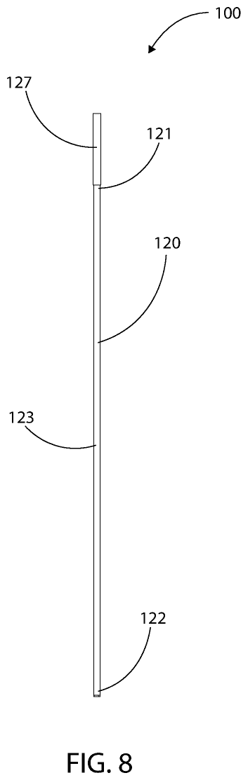

Referring now more specifically to the drawings by numerals of reference, there is shown in FIGS. 1-8, various views of an apparatus 100. As shown in these figures, the apparatus 100 may include a net 110, a first elongated pole 120 and a second elongated pole 130. As shown in FIGS. 1-4 particularly, the apparatus 100 may be used for skimming debris from a pool 5. It should be appreciated that the apparatus 100 is not limited to use with the size and/or shape of pool 5 shown in FIGS. 1-4. It should also be appreciated that the apparatus 100 may be used with other bodies of water and is not limited to use with pools.

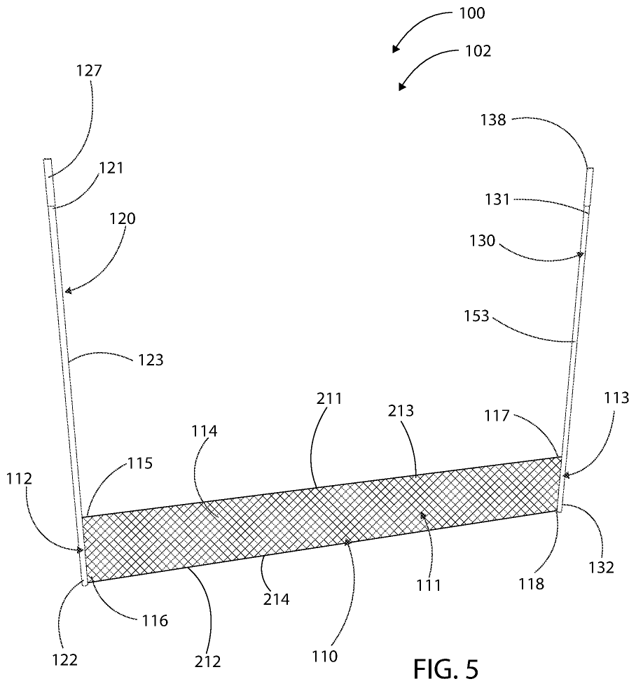

The net 110 may be configured to trap the debris thereon. As such, the net 110 may include a flexible mesh screen material 111 having a net surface for trapping the debris and a plurality of small openings therein to allow water to flow freely therethrough whilst preventing the debris from escaping therethrough. In some embodiments, the net 110 may be made from seine netting. Further, as shown in FIG. 5, the net 110 may include a first side 112 opposite a second side 113 and an elongate net length 114 therebetween.

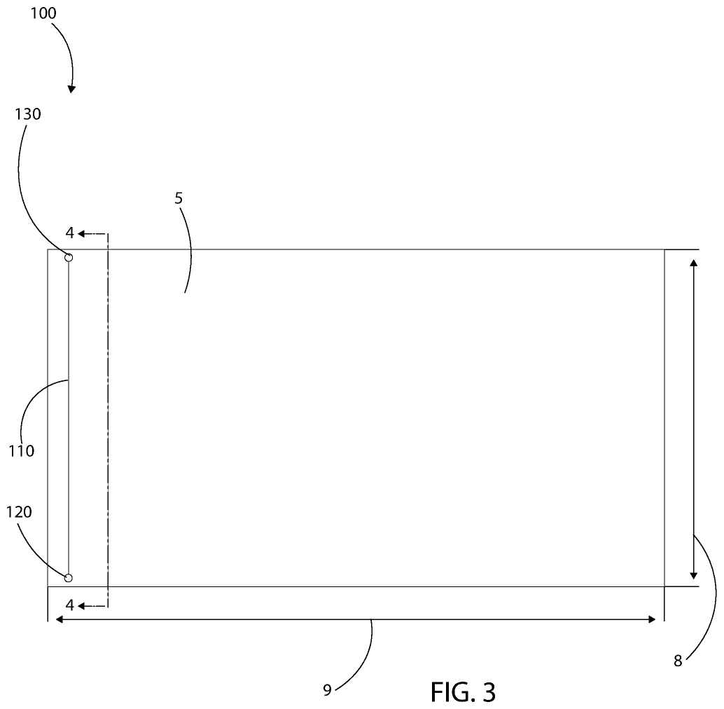

The elongate net length 114 may be substantially equal to either a width 8 or length 9 of the pool 5 (FIG. 3), thereby enabling the apparatus 100 to span between two sides of the pool 5. Particularly, as shown in FIGS. 1-4, the elongate net length 114 may be substantially equal to the width 8 of the pool 5. For example, the pool 5 may include a width 8 of 18 feet; and as such, the elongated net length 114 may be 18 feet (it should be appreciated that this measurement is given as an example only). In this embodiment, a first user 10 (FIG. 1) may stand on a first pool side 3 of the width 8 and a second user 15 (FIG. 1) may stand on a second pool side 4 of the width 8 (the second pool side 4 being opposite the first pool side 3). The first user 10 and the second user 15 may then walk simultaneously from a third pool side 6 of the length 9 to a fourth pool side 7 of the length 9 (the fourth pool side 7 being opposite the third pool side 6). This may enable the apparatus 100 to reach all areas of the pool 5, ensuring that the apparatus 100 skims as much of the debris as quickly as possible.

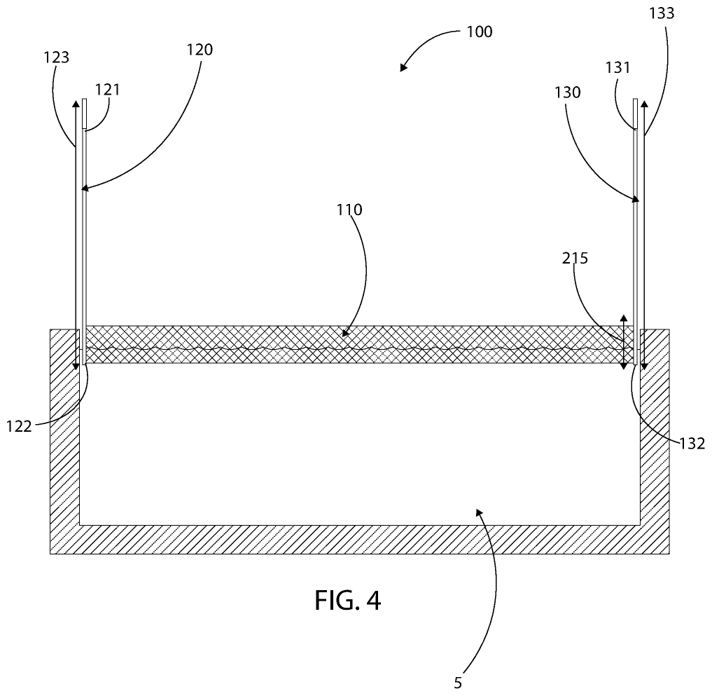

As shown in FIG. 5 particularly, the net 110 may include a rectangular configuration. As such, the first side 112 may include a first top corner 115 and a first bottom corner 116; and the second side 113 may include a second top corner 117 and a second bottom corner 118. The rectangular configuration of the net 110 may further aid in enabling the apparatus 100 to reach all areas of the pool 5 and thus skim as much of the debris as quickly as possible. It should however be appreciated that the net 110 is not limited to a rectangular configuration. Further, as demonstrated in FIG. 4, the net 110 may include a height 215 of between 15-25 inches, as measured from a top edge 211 thereof and a bottom edge 212 thereof (or from the top corners 115, 117 to the bottom corners 116, 118). For example, the net 110 may include a height 215 of 20 inches. It should however be appreciated that the net is not limited to this height 215.

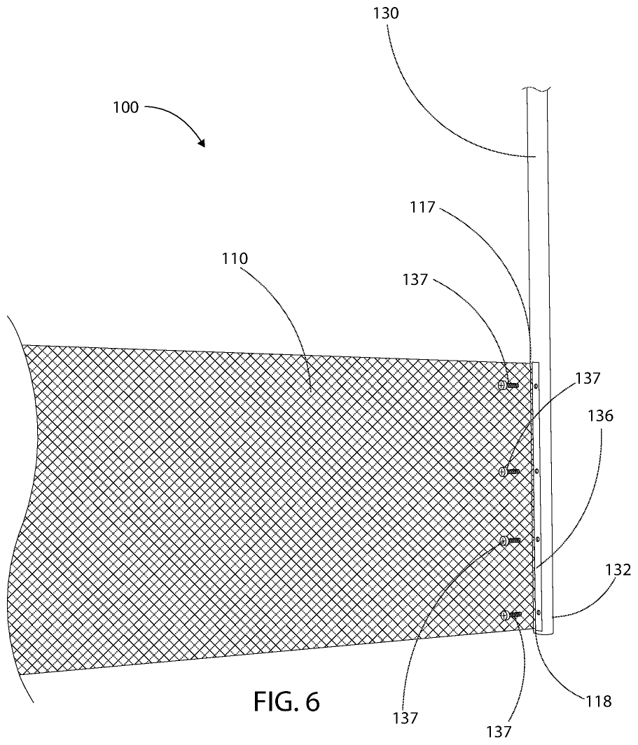

The net 110 may preferably be movable between an in-use position 102 and a storage position 103. As such, as discussed above, the net 110 may be flexible to enable the net 110 to easily fold. Preferably, as shown in FIG. 6, the net 110 may be rolled into the storage position 103. In one example, the elongated poles 120, 130 may be rolled together to roll the net 110 around the elongated poles 120, 130, similar to a scroll. In another example, the net 110 may be rolled around either the first elongated pole 120 or the second elongated pole 130.

As shown in FIG. 5, the net 110 may further include a top edge 211 and a bottom edge 212. Further, the net 110 may include a first support member 213 extending along the top edge 211 and a second support member 214 extending along the bottom edge 212. The support members 213, 214 may be configured to support the net 110 in the in-use position 102. Particularly, the support members 213, 214 may hold the net 110 straight. In some examples, the support members 213, 214 may include wire, such as fishing wire.

As shown in FIG. 5, the first elongated pole 120 may include a first top end 121 opposite a first bottom end 122 and a first elongated pole length 123 therebetween; similarly, the second elongated pole 130 may include a second top end 131 opposite a second bottom end 132 and a second elongated pole length 133 therebetween. In some embodiments, the elongated poles 120, 130 may be made from an aluminum material. As shown in FIG. 1, the first elongated pole 120 may be configured to be grasped by the first user 10 and the second elongated pole 130 may be configured to be grasped by the second user 15. As such, the first top end 121 may include a first handle portion 127 and the second top end 131 may include a second handle portion 138, as shown in FIG. 5 and FIGS. 7-8. In some embodiments, the handle portions 127, 138 may include non-slip material, such as silicone, rubber, etc.

As shown in FIG. 5 particularly, the first side 112 of the net 110 may be attached about the first bottom end 122 of the first elongated pole 120; and the second side 113 of the net 110 may be attached about the second bottom end 132 of the second elongated pole 130. Particularly, the first bottom corner 116 of the net 110 may be attached to the first bottom end 122 of the first elongated pole 120; and the second bottom corner 118 may be attached to the second bottom end 118 of the second elongated pole 130. In some embodiments, the first bottom corner 116 may be attached to the first bottom end 122 via at least one first fastener means. Likewise, the second bottom corner 118 may be attached to the second bottom end 132 via at least one second fastener means. For example, as shown in FIG. 6, the fastener means may each include a metal bar 136 such as aluminum rail, and four screws 137 (two bars 136 and eight screws 137 in total for the apparatus 100). In some examples, the screws 137 may be small aluminum screws.

As demonstrated in FIG. 4, the first elongated pole length 123 may measure between 60-80 inches long as measured from the first top end 121 to the first bottom end 122; and the second elongated pole length 133 may measure between 60-80 inches long as measured from the second top end 131 to the second bottom end 132. For example, in some embodiments, the pole lengths 123, 133 may measure 72 inches. It should however be appreciated that the pole lengths 123, 133 are not limited to this length. The first user 10 and the second user 15 may grip the top ends 121, 131 (or the handle portions 127, 138) of the elongated poles 120, 130 and ‘dip’ the net 110 into the pool 5 by inserting the bottom ends 122, 132 of the elongated poles 120, 130 into the pool 5.

According to another embodiment of the present disclosure, a method for using an apparatus 100 to skim debris from a pool 5 may be disclosed herein. The method may include the steps of providing the apparatus 100; standing the first user 10 at the first pool side 3 of the width 8 of the pool 5; standing the second user 15 at the second pool side 4 of the width 8 of the pool 5, the first pool side 3 being opposite the second pool side 4; placing the first elongated pole 120 into a hand of the first user 10; placing the second elongated pole 130 into a hand of the second user 15; simultaneously dipping the bottom ends 122, 132 of the elongated poles 120, 130 into the pool 5, thereby placing the net 110 into the pool 5; simultaneously walking from the third pool side 6 of the length 9 of the pool 5 to the fourth pool side 7 of the length 9 of the pool 5, whilst keeping the net 110 in the pool 5, thereby skimming debris from the pool 5; and removing the net 110 from the pool 5, thereby removing the debris from the pool 5.

It should be noted that certain steps are optional steps and may not be implemented in all cases. should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for skimming debris from a pool are taught herein.

It should be appreciated that the measurements given here are given as examples only and not meant to be limiting. The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An apparatus for skimming debris from a pool, the apparatus comprising:
a net including a flexible mesh screen material, a first side opposite a second side and an elongate net length therebetween, the elongate net length being substantially equal to one of a width and length of the pool, the net being configured to trap the debris thereon;
a first elongated pole configured to be grasped by a first user, the first elongated pole including a first top end opposite a first bottom end and a first elongated pole length therebetween, the first side of the net attached about the first bottom end of the first elongated pole; and
a second elongated pole configured to be grasped by a second user, the second elongated pole including a second top end opposite a second bottom end and a second elongated pole length therebetween, the second side of the net attached about the second bottom end of the second elongated pole.

2. The apparatus of claim 1, wherein the net is movable between an in-use position and a storage position.

3. The apparatus of claim 2, wherein the net is rolled into the storage position.

4. The apparatus of claim 1, wherein the first elongated pole includes a first handle portion and wherein the second elongated pole includes a second handle portion.

5. The apparatus of claim 4, wherein the first elongated pole length measures between 60-80 inches long as measured from the first top end to the first bottom end, and wherein the second elongated pole length measures between 60-80 inches long as measured from the second top end to the second bottom end.

6. The apparatus of claim 5, wherein the elongate net length is substantially equal to the width of the pool.

7. The apparatus of claim 6, wherein the net includes a rectangular configuration, wherein the first side includes a first top corner and a first bottom corner, and wherein the second side includes a second top corner and a second bottom corner.

8. The apparatus of claim 7, wherein a top edge of the net includes a first support member extending therealong, and wherein a bottom edge of the net includes a second support member extending therealong.

9. The apparatus of claim 8, wherein the first support member and the second support member are configured to support the net in the in-use position.

10. The apparatus of claim 9, wherein the first support member and the second support member each include fishing wire.

11. The apparatus of claim 10, wherein the net includes a height of between 15-25 inches as measured from the top edge to the bottom edge.

12. The apparatus of claim 11, wherein the first bottom corner is attached to the first bottom end and wherein the second bottom corner is attached to the second bottom end.

13. An apparatus for skimming debris from a pool, the apparatus comprising:
a net including a flexible mesh screen material and a rectangular configuration, the net further including a first side opposite a second side, an elongate net length therebetween, a top edge and a bottom edge, the first side having a first top corner and a first bottom corner, the second side having a second top corner and a second bottom corner, the elongate net length being substantially equal to a width of the pool, the net being configured to trap the debris thereon and wherein the net is movable between an in-use position and a storage position;
a first elongated pole configured to be grasped by a first user, the first elongated pole including a first top end opposite a first bottom end, a first elongated pole length therebetween and a first handle portion; and
a second elongated pole configured to be grasped by a second user, the second elongated pole including a second top end opposite a second bottom end, a second elongated pole length therebetween and a second handle portion; and
wherein the first bottom corner is attached to the first bottom end and wherein the second bottom corner is attached to the second bottom end.

14. The apparatus of claim 13, wherein the first elongated pole length measures between 60-80 inches long as measured from the first top end to the first bottom end, and wherein the second elongated pole length measures between 60-80 inches long as measured from the second top end to the second bottom end.

15. The apparatus of claim 14, wherein the net includes a height of between 15-25 inches as measured from a top edge to a bottom edge.

16. The apparatus of claim 15, wherein the net is rolled into the storage position.

17. The apparatus of claim 16, wherein a top edge of the net includes a first support member extending therealong, and wherein a bottom edge of the net includes a second support member extending therealong.

18. The apparatus of claim 17, wherein the first support member and the second support member are configured to support the net in the in-use position.

19. The apparatus of claim 18, wherein the first support member and the second support member each include fishing wire.

20. An apparatus for skimming debris from a pool, the apparatus comprising:
a net including a flexible mesh screen material and a rectangular configuration, the net further including a first side opposite a second side, an elongate net length therebetween, a top edge, a bottom edge and a height of between 15-25 inches as measured from the top edge to the bottom edge, the first side having a first top corner and a first bottom corner, the second side having a second top corner and a second bottom corner, the top edge of the net including fishing wire extending therealong, the bottom edge of the net including the fishing wire extending therealong, the elongate net length being substantially equal to a width of the pool and configured to trap the debris thereon, the net further being movable between an in-use position and a storage position, wherein the net is rolled into the storage position, and wherein the fishing wire along the top edge and the bottom edge is configured to support the net in the in-use position;
a first elongated pole configured to be grasped by a first user, the first elongated pole including a first top end opposite a first bottom end, a first elongated pole length therebetween and a first handle portion, the first elongated pole length measuring between 60-80 inches long as measured from the first top end to the first bottom end; and
a second elongated pole configured to be grasped by a second user, the second elongated pole including a second top end opposite a second bottom end, a second elongated pole length therebetween and a second handle portion, the second elongated pole length measuring between 60-80 inches long as measured from the second top end to the second bottom end; and
wherein the first bottom corner is attached to the first bottom end and wherein the second bottom corner is attached to the second bottom end.
